(19) United States
(12) Patent Application Publication
(10) Pub. No.: US 2025/0259346 A1
(43) Pub. Date: Aug. 14, 2025

(54) METHOD, SERVER, AND COMPUTER PROGRAM FOR GENERATING RELIGHTED IMAGE BASED ON OBJECT IMAGE

(71) Applicant: Beeble Inc., Seoul (KR)

(72) Inventors: Hoon KIM, Seoul (KR); Minje JANG, Seoul (KR); Wonjun YOON, Seoul (KR); Jisoo LEE, Suwon-si (KR); Donghyun NA, Seoul (KR); Sanghyun WOO, Daejeon (KR)

(73) Assignee: Beeble Inc., Seoul (KR)

(21) Appl. No.: 19/046,631

(22) Filed: Feb. 6, 2025

(30) Foreign Application Priority Data
Feb. 8, 2024 (KR) 10-2024-0019813
Apr. 22, 2024 (KR) 10-2024-0053212

(51) Int. Cl. G06T 11/00; G06T 7/00

(52) U.S. Cl. CPC G06T 11/001; G06T 7/0002; G06T 2207/20081; G06T 2207/20084

(57) ABSTRACT

Disclosed is a method of generating a relighted image based on an object image according to various embodiments of the present invention for realizing the problems described above. The method includes acquiring a source original image, acquiring image characteristic information based on the source original image, and generating the relighted image based on the source original image, the image characteristic information, and target lighting information, in which the relighted image is an image reflecting a realistic human skin tone, texture, and a shadow effect under the target lighting conditions, and is an image whose a lighting effect is changed compared to the source original image.

### CROSS-REFERENCE TO RELATED APPLICATION

This application claims priority to and the benefit of Korean Patent Application No. 10-2024-0053212, filed on Apr. 22, 2024, and Korean Patent Application No. 10-2024-0019813, filed on Feb. 8, 2024, the disclosure of which is incorporated herein by reference in its entirety.

### BACKGROUND

### 1. Field of the Invention

Various embodiments of the present invention relate to a method of generating a relighted image, and more particularly, to a method, server, and computer program for changing relighting conditions of digital images.

### 2. Discussion of Related Art

The fields of digital image processing and computer graphics are rapidly developing in modern society, which has led to a continuous increase in the demand for high-quality digital content. At the center of these trends, relighting technology for changing lighting conditions of portraits is receiving special attention. The relighting technology plays an important role in reproducing portrait images under more realistic and diverse lighting environments in various application fields such as movie production, digital art, and virtual reality.

In the fields such as virtual reality and augmented reality, an operation that generates an integrated scene by combining individual object images captured under various lighting conditions may be essential. The application of the relighting technology may provide natural lighting consistency to the entire scene beyond the original lighting environment of each object in this operation, thereby providing a more immersive experience to users and greatly improving the realism of the virtual environment.

However, in particular, in relation to the portraits, an operation of targeting realistic transformation of subjects under various lighting conditions remains a challenging problem that has not been technically clearly defined due to complex lighting effects and diverse characteristics of the subjects. Conventional methodologies have actively utilized information from 3D face models and utilized intrinsic characteristics of images, and in some cases, have been interpreted and approached as a problem of style transition, but have shown limitations in properly handling subtle phenomena such as complex non-Lambertian effects.

In this situation, light stage technology has been proposed as a method to capture the diversity of lighting. The light stage technology has shown great potential in capturing reflection characteristics of subjects in detail according to lighting changes by precisely recording a response of subjects under various lighting conditions. However, the actual application of this technology involves practical difficulties such as the need for highly specialized equipment and the considerable time and effort required for large-scale data collection.

Recently, the development of deep learning technology has suggested a solution to this problem. A relighting method using a neural network trained based on optical stage data has made great progress in automating the relighting of portraits according to the lighting changes. However, this approach still has limitations in completely simulating interactions of complex light such as the non-Lambertian effect.

Accordingly, there is a continuous demand for research and development in the art for the development of more advanced modeling techniques and algorithms.

### RELATED ART DOCUMENT

### Patent Document

Korean Patent Laid-Open Publication No. 10-2022-0117324

### SUMMARY OF THE INVENTION

The present invention is directed to providing a method of changing lighting conditions of a portrait image to be natural and realistic.

Objects of the present invention are not limited to the above-mentioned objects. That is, other objects that are not mentioned may be obviously understood by those skilled in the art from the following description.

According to an aspect of the present invention, there is provided a method of generating relighted image based on an object image. The method may include acquiring a source original image, acquiring image characteristic information based on the source original image, and generating the relighted image based on the source original image, the image characteristic information, and target lighting information.

The relighted image may be an image reflecting characteristics of an object under target lighting conditions, and an image whose lighting effect is changed compared to the source original image.

The relighted image may be an image reflecting a realistic human skin tone, texture, and shadow effect under the target lighting conditions.

The acquiring of the image characteristic information may include extracting a foreground image from the source original image through a foreground extraction model, and performing reverse rendering on the extracted foreground image to acquire the image characteristic information, in which the image characteristic information may be information on physical and optical properties of a surface corresponding to the foreground image, and include at least one of a normal map, an albedo map, information on roughness, information on reflectivity, and lighting condition information.

The performing of the reverse rendering to acquire the image characteristic information may include deriving the normal map corresponding to the source original image using a normal map generation model, deriving the lighting condition information corresponding to the source original image using a lighting condition inference model, generating diffuse shading based on the normal map and the lighting condition information, generating the albedo map based on the diffuse shading, and acquiring the information on the roughness and the reflectivity corresponding to the source original image based on the source original image, the normal map, and the albedo map.

The generating of the albedo map based on the diffuse shading may include processing the source original image and the diffuse shading as inputs to a diffuse model to acquire a diffuse render, and generating the albedo map based on the diffuse shading and the diffuse render, in which the diffuse model may include a pre-trained network function to output the diffuse render based on the diffuse shading corresponding to the source original image, and the diffuse render may be a final image generated by combining the diffuse shading and the albedo map, and an image in which a diffuse effect which is spreading light evenly in all directions from the surface is visually expressed.

The acquiring of the information on the roughness and the reflectivity corresponding to the source original image based on the source original image, the normal map, and the albedo map may include processing the source original image, the normal map, and the albedo map as inputs to a specular model to acquire the information on the roughness and the reflectivity, and the specular model may include a pre-trained network function to acquire specular information including the information on the roughness and the reflectivity by inferring a specular element of the surface based on microsurface theory.

The generating of the relighted image may include generating a diffuse render and a specular render based on the normal map, the albedo map, the information on the roughness, the information on the reflectivity, and the target lighting information, generating an initial relighted image based on the diffuse render and the specular render, and processing the initial relighted image as an input of a rendering model to generate the relighted image, in which the rendering model may be a pre-trained neural network model based on an integrated loss related to a weighted sum of a reconstruction loss, a perceptual loss, an adversarial loss, and a specular loss, and the reconstruction loss may be a loss related to a pixel-level difference between an original image and a predicted result image corresponding to the original image, the perceptual loss may be a loss related to a characteristic difference between the original image and the result image, the adversarial loss may be a loss related to a difference between the original image determined by a discriminator model and the result image, and the specular loss may be a loss obtained by weighting the reconstruction loss using specular information.

The method may further include constructing a training data set based on a plurality of optical stage data, generating a plurality of reconstructed images corresponding to each of a plurality of source original images included in the training data set by using an image reconstruction model, and reinforcing the training data set based on the plurality of reconstructed images, in which the image reconstruction model may be trained to generate the reconstructed image corresponding to an input image by reflecting the perceptual loss and the adversarial loss in the reconstruction loss regarding the difference between each source original image and each reconstructed image corresponding to each source original image.

The image reconstruction model may be trained to generate the plurality of reconstructed images by using dynamic masking that dynamically adjusts one or more patches with various sizes to various areas of the input image.

According to another aspect of the present invention, there is provided a server for performing the method of generating relighted image based on an object image. The server includes a memory configured to store one or more instructions, and a processor configured to execute the one or more instructions stored in the memory, in which the processor may execute the one or more instructions to perform the above-described method of generating relighted image based on an object image.

Another aspect of the present disclosure provides a computer-readable recording medium, which stores instructions that, when executed, perform a method of generating a relighted image based on an object image. Other detailed contents of the present invention are described in a detailed description and are illustrated in the drawings.

### BRIEF DESCRIPTION OF DRAWINGS

The above and other objects, features and advantages of the present invention will become more apparent to those of ordinary skill in the art by describing exemplary embodiments thereof in detail with reference to the accompanying drawings, in which:

FIG. 1 is an exemplary diagram schematically illustrating a system for implementing a method of generating a relighted image based on an object image according to an embodiment of the present invention;

FIG. 2 is a diagram illustrating an exemplary relighted image under various lighting environments;

FIG. 3 is a hardware configuration diagram of a server performing the method of generating a relighted image based on an object image according to an embodiment of the present invention;

FIG. 4 is a flowchart exemplarily illustrating the method of generating a relighted image based on an object image according to an embodiment of the present invention;

FIG. 5 is an exemplary diagram for describing an original image and essential properties corresponding to the original image according to an embodiment of the present invention;

FIG. 6 is an exemplary diagram illustrating architecture for performing the method of generating a relighted image based on an object image according to an embodiment of the present invention;

FIG. 7 is an exemplary diagram illustrating a process of generating a relighted image according to an embodiment of the present invention;

FIG. 8 is an exemplary diagram illustrating images to which a relighting effect is applied according to the method of generating a relighted image based on an object image according to an embodiment of the present invention; and

FIG. 9 is an exemplary diagram for describing dynamic masking of an image reconstruction model according to an embodiment of the present invention.

### DETAILED DESCRIPTION OF EXEMPLARY EMBODIMENTS

Hereinafter, various embodiments will be described with reference to the drawings. In this specification, various descriptions are presented to provide an understanding of the invention. However, it is obvious that these embodiments may be practiced without these specific descriptions.

The terms used herein “component”, “module”, “system”, etc., refer to a computer-related entity, hardware, firmware, software, a combination of software and hardware, or an implementation of software. For example, the component may be, but is not limited to, a procedure running on a processor, a processor, an object, an execution thread, a program, and/or a computer. For example, both an application running on a computing device and the computing device may be a component. One or more components may reside within a processor and/or execution thread. One component may be localized within one computer. One component may be distributed between two or more computers. In addition, these components may be executed from various computer-readable media having various data structures stored therein. Components may communicate via local and/or remote processes (e.g., data from one component interacting with other components in a local system and a distributed system and/or data transmitted to other systems via networks such as the Internet according signals), for example according to signals with one or more data packets.

In addition, the term “or” is intended to mean an inclusive “or”, not an exclusive “or.” That is, unless otherwise specified or clear from context, “X uses A or B” is intended to mean one of the natural implicit substitutions. That is, when either X uses A; X uses B; or X uses both A and B, “X uses A or B” may apply to either of these cases. In addition, the term “and/or” used herein should be understood to refer to and include all possible combinations of one or more of the related items listed.

In addition, the terms “include” and/or “including” should be understood to mean that the corresponding feature and/or component is present. However, the terms “include” and/or “including” should be understood as not excluding the presence or addition of one or more other features, components and/or groups thereof. In addition, unless otherwise specified or the context is clear to indicate a singular form, the singular form in the present specification and in the claims should generally be construed to mean “one or more.”

In addition, those skilled in the art should recognize that various illustrative logical blocks, configurations, modules, circuits, means, logic, algorithms, and steps described in connection with the embodiments disclosed herein may be implemented by electronic hardware, computer software, or a combination of both. To clearly illustrate interchangeability of hardware and software, various illustrative components, blocks, configurations, means, logics, modules, circuits, and steps have been described above generally in terms of their functionality. Whether such functionality is implemented by hardware or software will depend on the specific application and design constraints imposed on the overall system. Those skilled in the art may implement the described functionality in a variety of ways for each specific application. However, such implementation determinations should not be construed as departing from the scope of the present invention.

The description of the presented embodiments is provided to enable those skilled in the art to make or use the present invention. Various modifications to these embodiments will be apparent to those skilled in the art. The general principles defined herein may be applied to other embodiments without departing from the scope of the invention. Therefore, the present invention is not limited to the embodiments presented herein. The present invention should be interpreted in the broadest scope consistent with the principles and novel features presented herein.

In this specification, a computer means all kinds of hardware devices including at least one processor, and can be understood as including a software configuration which is operated in the corresponding hardware device according to the embodiment. For example, the computer may be understood as a meaning including all of smart phones, tablet PCs, desktops, laptops, and user clients and applications running on each device, but is not limited thereto.

Hereinafter, embodiments of the present invention will be described in detail with reference to the accompanying drawings.

Each step described in this specification is described as being performed by the computer, but subjects of each step are not limited thereto, and according to embodiments, at least some of each steps can also be performed on different devices.

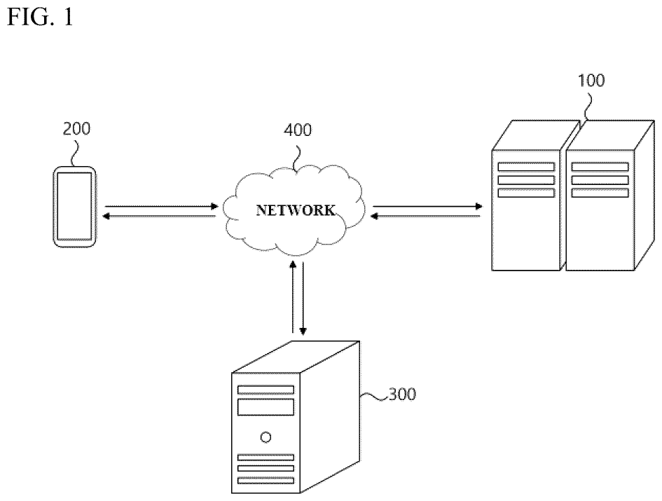

FIG. 1 is an exemplary diagram schematically illustrating a system for implementing a method of generating a relighted image based on an object image according to an embodiment of the present invention.

As illustrated in FIG. 1, a system according to embodiments of the present invention may include a server 100, a user terminal 200, an external server 300, and a network 400. The components illustrated in FIG. 1 are exemplary, and additional components may exist or some of the components illustrated in FIG. 1 may be omitted. The server 100, the external server 300, and the user terminal 200 according to embodiments of the present invention may transmit and receive data for the system according to embodiments of the present invention to and from each other through the network 400.

The network 400 according to embodiments of the present invention may use various wired communication systems such as a public switched telephone network (PSTN), an x digital subscriber line (xDSL), a rate adaptive DSL (RADSL), a multi rate DSL (MDSL), a very high speed DSL (VDSL), a universal asymmetric DSL (UADSL), a high bit rate DSL (HDSL), and a local area network (LAN).

In addition, the network 400 presented herein may use various wireless communication systems such as code division multi access (CDMA), time division multi access (TDMA), frequency division multi access (FDMA), orthogonal frequency division multi access (OFDMA), single carrier-FDMA (SC-FDMA), and other systems.

The network 400 according to the embodiments of the present invention may be configured regardless of a communication mode, such as wire and wireless, and may be configured with various communication networks, such as a short-range communication network (personal area network (PAN)) and a local area network (wide area network (WAN)). In addition, the communication network 400 may be the known World Wide Web (WWW) and use a wireless transmission technology used in short-range communication such as infrared data association (IrDA) or Bluetooth. The technologies described in this specification may be used not only in the networks described above, but also in other networks.

According to an embodiment of the present invention, the server 100 (hereinafter, “server 100”) that performs the method of generating a relighted image based on an object image may generate and provide a relighted image that reflect a change in lighting conditions for a source original image. Specifically, the server 100 may extract essential image properties (i.e., image characteristic information) from the source original image, and generate the relighted image that matches the target lighting conditions based on the extracted image properties. This process may include separating foreground and background, extracting intrinsic characteristic information such as a normal map and an albedo map, re-rendering an image under target lighting based on the extracted information, etc. That is, the server 100 may implement a realistic relighting effect of an object under the lighting conditions specified by the user through the processing described above.

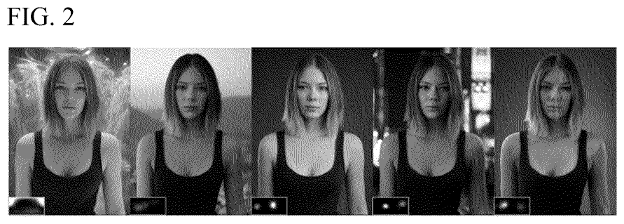

In the present invention, the relighted image may mean an image modified to reflect new lighting conditions specified by the user. The relighted image may be an image reflecting the characteristics of the object under the target lighting conditions. For example, the object may be a person or an object, but is not limited thereto, and may be various subjects such as landscapes or animals. For example, the relighted image may be a result that naturally expresses the skin tone, texture, shadow, etc., of a person while the direction, intensity, color, etc., of lighting are changed. For a specific example, as illustrated in FIG. 2, the relighted image may allow a user to experience realistic changes under various lighting conditions compared to an original image. This may be applied to a portrait image to simulate a lighting environment that does not actually exist, or to create a specific time zone or a special atmosphere.

According to an embodiment, the server 100 may generate a reconstructed image with changed lighting according to user's needs by using architecture that integrates a physics-based approach and a self-supervised pre-training framework.

In a specific embodiment, the server 100 may meticulously simulate the interaction between light and surface microfacets that consider spatially varying roughness and reflectivity through a relighted image generation model that is the physics-based model. For example, the relighted image generation model may be the physics-based model based on a Cook-Torrance reflection model, and may provide a relighted image that reflects a high level of realism by maximizing realism.

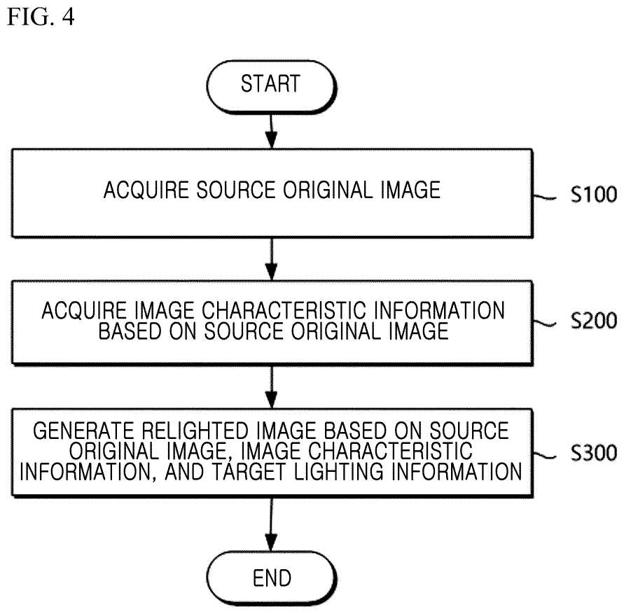

In addition, the server 100 may implement a framework using an image reconstruction model to overcome limitations of optical stage data that are generally difficult to acquire. For example, the image reconstruction model may adopt a multi-masked autoencoder (MMAE) or a similar self-supervised learning method, thereby enabling training on unlabeled data. The MMAE may train important features from various parts of an input image by applying various masks, and achieve precise reconstruction of the image based on the trained features. As a result, the server 100 may extract deep image features without labeling data, and utilize the extracted deep image features in the relighted image generation process to generate more sophisticated and realistic results. In other words, the server 100 may perform the training on the unlabeled data by using the image reconstruction model, thereby improving the realism of the finally generated relighted image. This has the advantage of enabling specific relighting operations to be performed more effectively through fine-tuning without relying on the optical stage data. In other words, the server 100 may perform the training on the unlabeled data through the self-supervised pre-training framework and provide the realistic relighted images tailored to the user's needs based on the training. As a result, the server 100 may automate the relighting of the image reflecting the lighting changes in various real-world scenarios by using the architecture that integrates the physics-based approach and the self-supervised pre-training framework, and provide the enhanced realism to the user. A more specific description of the method of generating relighted image based on an object image performed by the server will be described later with reference to FIG. 4.

In an embodiment, only one server 100 is illustrated in FIG. 1, but it will be apparent to those skilled in the art that more servers may also be included in the scope of the present invention and that the server 100 may include additional components. That is, the server 100 may be composed of a plurality of computing devices. In other words, a set of nodes may constitute the server 100.

According to an embodiment of the present invention, the server 100 may be a server providing a cloud computing service. More specifically, the server 100 is a type of Internet-based computing and may be a server that provides the cloud computing service that processes information not with the user's computer but with another computer connected to the Internet. The cloud computing services may be services that may store data on the Internet and allow users to use necessary data or programs anytime, anywhere through Internet access without having to install the necessary data or programs on their computers, and allow the users to easily share and deliver data stored on the Internet with simple operations and clicks. In addition, the cloud computing services may be services that may not only simply store data in a server on the Internet, but may also perform desired tasks using functions of application programs provided on a web without having to install a separate program, and allow multiple people to perform tasks while sharing documents at the same time. In addition, the cloud computing services may be implemented in at least one of the following forms: Infrastructure as a Service (IaaS), Platform as a Service (PaaS), Software as a Service (SaaS), a virtual machine-based cloud server, and a container-based cloud server. That is, the server 100 of the present invention may be implemented in the form of at least one of the above-described cloud computing services. The specific description of the cloud computing services described above is an example, and the present invention may include any platform for building a cloud computing environment.

The user terminal 200 according to an embodiment of the present invention may refer to any type of node(s) in the system that has a mechanism for communication with the server 100. The user terminal 200 is a terminal that may receive an optimized relighted image through information exchange with the server 100, and may mean a terminal possessed by a user.

For example, the user terminal 200 may perform operations such as uploading an original image to the server 100 through a smartphone or a tablet, and downloading an image (i.e., a relighted image) with changed lighting from the server. In this process, the user may confirm the image to which the highly realistic relighting effect processed by the server 100 is applied in real time, and experiment various lighting settings as needed.

According to an embodiment, when the server 100 receives the source original image (e.g., an original portrait image) from the user terminal 200, the server 100 may extract intrinsic image property information based on the received source original image and generate the relighted image according to the target lighting conditions. For example, the source original image uploaded from the user terminal 200 is first separated into a main object of the image through a foreground extraction model within the server 100, and then, identify intrinsic properties, such as a normal map, an albedo map, roughness, and reflectivity, through a reverse rendering process. This information and new lighting conditions selected by the user are input into the relighted image generation model, so the relighted image with the realistic relighting effect applied under the final modified lighting conditions may be generated. Through this process, the user may simulate an object under various lighting environments, which may be utilized for artistic creation or practical purposes.

The user terminal 200 may refer to any type of entity(s) in the system that has a mechanism for communication with the server 100. For example, the user terminal 200 may include a personal computer (PC), a note book, a mobile terminal, a smart phone, a tablet personal computer (tablet PC), a wearable device, etc., and may include all types of terminals that may access wired/wireless networks. In addition, the user terminal 200 may include any server implemented by at least one of an agent, an application programming interface (API), and a plug-in. In addition, the user terminal 200 may include an application source and/or a client application.

In an embodiment, the external server 300 may be connected to the server 100 via the network 400, and may provide various information/data required for the server 100 to perform the method of generating a relighted image based on an object image, or may receive, store, and manage result data derived by performing the method of generating a relighted image based on an object image. For example, the external server 300 may be a storage server separately provided outside the server 100, but is not limited thereto.

In addition, in the embodiment, the information stored in the external server 300 may be utilized as training data, verification data, and test data for training the artificial neural network of the present invention. That is, the external server 300 may store data for training the artificial intelligence model of the present invention. The server 100 of the present invention may construct a plurality of training data sets based on the information received from the external server 300. The server 100 may perform training on one or more network functions through each of the plurality of training data sets, thereby generating a plurality of artificial intelligence models.

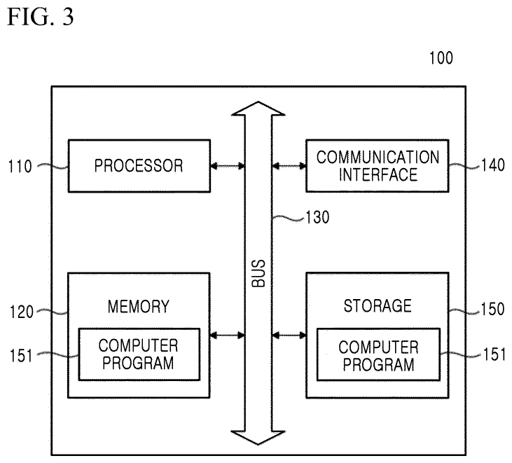

The external server 300 may be a digital device, and a digital device including a processor and a memory and capable of computing ability, such as a laptop computer, a notebook computer, a desktop computer, a web pad, or a mobile phone. The external server 300 may be a web server that processes a service. A type of servers described above is merely examples, and the present disclosure is not limited thereto. Hereinafter, referring to FIG. 3, the hardware configuration of the server 100 that performs the method of generating a relighted image based on an object image will be described.

FIG. 3 is a hardware configuration diagram of the server performing the method of generating a relighted image based on an object image according to an embodiment of the present invention.

Referring to FIG. 3, the server 100 performing the method of generating a relighted image based on an object image according to an embodiment of the present invention may include one or more processors 110, a memory 120 into which a computer program 151 executed by the processor 110 is loaded, a bus 130, a communication interface 140, and a storage 150 for storing the computer program 151. Here, only the components related to the embodiment of the present invention are illustrated in FIG. 3. Accordingly, those skilled in the art to which the present invention pertains may understand that other general-purpose components other than those illustrated in FIG. 3 may be further included.

According to an embodiment of the present invention, the processor 110 may generally process the overall operation of the server 100. The processor 110 may provide or process appropriate information or functions to the user or user terminal by processing signals, data, information, and the like, which are input or output through the above-described components, or by driving an application program stored in the memory 120.

In addition, the processor 110 may perform calculations on at least one application or program for executing the method according to the embodiments of the present invention, and the server 100 may include one or more processors.

According to an embodiment of the present invention, the processor 110 may be composed of one or more cores, and may include a processor for data analysis and deep learning, such as a central processing unit (CPU), a general purpose graphics processing unit (GPGPU), a tensor processing unit (TPU), etc., of a computing device.

The processor 110 may read a computer program stored in the memory 120 to provide the method of generating a relighted image based on an object image according to an embodiment of the present invention.

In various embodiments, the processor 110 may further include a random access memory (RAM) (not illustrated) and a read-only memory (ROM) for temporarily and/or permanently storing signals (or data) processed in the processor 110. In addition, the processor 110 may be implemented in the form of a system-on-chip (SoC) including at least one of a graphics processing unit, a RAM, and a ROM.

The memory 120 stores various data, commands, and/or information. The memory 120 may load the computer program 151 from the storage 150 to execute methods/operations according to various embodiments of the present invention. When the computer program 151 is loaded into the memory 120, the processor 110 may perform the method/operation by executing one or more instructions constituting the computer program 151. The memory 120 may be implemented as a volatile memory such as a RAM, but the technical scope of the present disclosure is not limited thereto.

The bus 130 provides a communication function between the components of the server 100. The bus 130 may be implemented as various types of buses, such as an address bus, a data bus, and a control bus.

The communication interface 140 supports wired/wireless Internet communication of the server 100. In addition, the communication interface 140 may support various communication manners other than the Internet communication. To this end, the communication interface 140 may be configured to include a communication module well known in the art of the present invention. In some embodiments, the communication interface 140 may be omitted.

The storage 150 may non-temporarily store the computer program 151. When performing a process of generating a relighted image based on an object image through the server 100, the storage 150 may store various pieces of information necessary to provide the process of generating a relighted image based on an object image.

The storage 150 may include a nonvolatile memory, such as a ROM, an erasable programmable ROM (EPROM), an electrically erasable programmable ROM (EEPROM), and a flash memory, a hard disk, a removable disk, or any well-known computer-readable recording medium in the art to which the present invention pertains.

The computer program 151 may include one or more instructions to cause the processor 110 to perform methods/operations according to various embodiments of the present invention when loaded into the memory 120. That is, the processor 110 may perform the method/operation according to various embodiments of the present invention by executing the one or more instructions.

In an embodiment, the computer program 151 may include one or more instructions to perform the method of generating a relighted image based on an object image that includes acquiring the source original image, acquiring the image characteristic information based on the source original image, and generating the relighted image based on the source original image, the image characteristic information, and the target lighting information.

Operations of the method or algorithm described with reference to the embodiment of the present invention may be directly implemented in hardware, in software modules executed by hardware, or in a combination thereof. The software module may reside in a RAM, a ROM, an EPROM, an EEPROM, a flash memory, a hard disk, a removable disk, a compact disc read-only memory (CD-ROM), or in any form of computer-readable recording media known in the art to which the invention pertains.

The components of the present invention may be embodied as a program (or application) and stored in media for execution in combination with a computer which is hardware. The components of the present invention may be executed in software programming or software elements, and similarly, embodiments may be realized in a programming or scripting language such as C, C++, Java, and assembler, including various algorithms implemented in a combination of data structures, processes, routines, or other programming constructions. Functional aspects may be implemented in algorithms executed on one or more processors. Hereinafter, the method of generating a relighted image based on an object image performed by the server 100 will be described in detail with reference to FIGS. 4 to 9.

FIG. 4 is a flowchart exemplarily illustrating the method of generating a relighted image based on an object image according to an embodiment of the present invention. The order of the operations illustrated in FIG. 4 may be changed as needed, and at least one operation may be omitted or added. That is, the following operations are only an example of the present invention, and the scope of the present disclosure is not limited thereto.

According to an embodiment of the present invention, the method of generating a relighted image based on an object image may include an operation S100 of acquiring the source original image. In an embodiment, the source original image may be acquired by receiving or loading data stored in a memory 120. In addition, the source original image may be acquired by receiving or loading the source original image from another storage medium, another computing device, or a separate processing module within the same computing device based on the wired/wireless communication means. For example, the source original image may be acquired from a smartphone, a tablet, or a digital camera of a user, and may be directly uploaded to the server 100 from these devices, or may be indirectly transmitted through cloud-based storage, email, a social media platform, etc. The acquired source original image may be stored in the memory 120 of the server 100 and prepared for the processing process. The user may transmit the source original image to the server via a wired or wireless network, and the server may receive the source original image and proceed with the relighting process.

In an embodiment, the source original image may be an original image related to a specific object. Here, the object may be one of a person, an animal, an object, or a landscape. In other words, the source original image may be an image captured in various subjects and environments and may be an image representing characteristics of an individual object. For example, the source original image may include a portrait of an individual or a group, a photo of a wild animal or a pet, a natural landscape or a cityscape, or a detailed photograph of a specific object.

In an embodiment, the source original image may mean an original portrait image. For example, the source original image may be a photo including a face of a user or another person. The source original image may be a photo captured by a user himself or herself, or an image acquired from a digital archive, a photo sharing platform, social media, etc., and the source original image may be used as an input to the relighting process to change the lighting conditions.

According to an embodiment of the present invention, the method of generating a relighted image based on an object image may include an operation S200 of acquiring the image characteristic information based on the source original image.

In an embodiment, the operation of acquiring the image characteristic information may include extracting a foreground image from the source original image through a foreground extraction model and performing reverse rendering on the extracted foreground image to acquire the image characteristic information.

According to an embodiment, the image characteristic information is information on physical and optical properties of a surface corresponding to the foreground image, and may include at least one of the pieces of information on the normal map, the albedo map, the roughness, the reflectivity, and the lighting information.

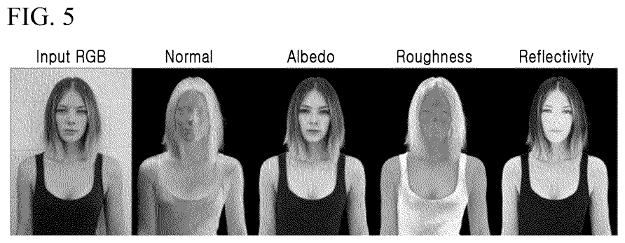

In an embodiment, referring to FIG. 5, data on each of the normal, albedo, roughness, and reflectivity corresponding to the source original image may represent various physical characteristics of the corresponding image. The characteristic information precisely expresses the directionality, color and texture of the surface, the roughness of the surface, and the degree of light reflection for each pixel or image area, and more sophisticated and realistic relighting effects may be implemented based on the characteristic information. The server 100 may utilize this information to determine how to light the image under the target lighting conditions, and ultimately generate the relighted image that reflects the lighting effect desired by the user.

In an embodiment, the foreground extraction model may be a neural network model trained to extract a foreground (e.g., a main object or person) from an input image (e.g., a source original image) by separating the foreground (e.g., a main object or person) from the background. The foreground extraction model may be generated through a supervised learning process using various image data sets, and in this process, a method of accurately distinguishing the foreground and background in the image may be pre-trained. As an example, the foreground extraction model may be a model related to a matting network. The matting network may be a neural network model that finely adjusts a boundary between the foreground and background for each pixel of an image and precisely extracts a foreground object from the image using an alpha matting technique. After the foreground extraction model may separate the foreground with high precision for an image provided by a user, the server 100 may acquire the image characteristic information based on the separated foreground image.

In an embodiment, the server 100 may perform the reverse rendering on the extracted foreground image to acquire the image characteristic information. In an embodiment, the reverse rendering may mean a process of reversely calculating and inferring the physical and optical properties of the surface from the image. This process may analyze a plurality of factors, such as the lighting, reflectivity, texture, and geometric shape of the extracted foreground image, to identify the information on how the image may be generated in the real world. Through the reverse rendering, the server 100 precisely extracts essential characteristic information of the image, such as the normal map, the albedo map, and the lighting information, and the image characteristic information may be utilized in a subsequent relighting process.

According to an embodiment of the present invention, the performing of the reverse rendering to acquire the image characteristic information may include deriving the normal map corresponding to the source original image using the normal map generation model, deriving lighting condition information corresponding to the source original image using a lighting condition inference model, generating diffuse shading based on the normal map and the lighting condition information, generating the albedo map based on the diffuse shading, and acquiring the information on the roughness and the reflectivity corresponding to the source original image based on the source original image, the normal map, and the albedo map.

Describing in more detail, the server 100 may generate the normal map based on the foreground image extracted from the source original image through the normal map generation model. Here, the normal map generation model may be NormalNet which identifies a slope and direction of a surface corresponding to each pixel in the image and generates the normal map based on the identified slope and direction, but is not limited thereto. The normal map generation model may analyze a physical shape and structure from the source image using a deep learning technique, and convert the analysis result into the normal map containing the direction information of the surface.

In an embodiment, the normal map may mean a visual representation representing the geometric shape and directionality of the surface. Each pixel of the normal map includes a unit normal vector n, and the vector may represent the direction of the corresponding surface point. In other words, the normal map represents directionality of each point forming a surface of a three-dimensional object as a two-dimensional image, and color values of each pixel encodes each component of the vector representing the directionality of the surface. The normal map generated in this way may be used to implement a more realistic lighting effect by considering the directionality of the surface in a subsequent relighting process.

In addition, in an embodiment, the server 100 may infer the lighting conditions of the foreground image extracted from the source original image by using a lighting condition inference model. The lighting conditions of the foreground image may mean the direction, intensity, color, distribution, etc., of an actual or virtual lighting source applied when capturing the source original image. Based on these lighting conditions and the normal map, the diffuse shading may be generated, which may contribute to imparting the realistic depth and texture to the image in the relighting process.

According to an embodiment, the lighting condition inference model is a model for accurately identifying and analyzing various lighting effects in a source image, and may be an Illum Net that identifies the characteristics of lighting and infers the lighting conditions based on the identified characteristics, but is not limited thereto. The Illum Net model may extract lighting-related information from an image using a deep learning-based algorithm and infer under what lighting conditions the image is captured. In an embodiment, the lighting condition information acquired through the lighting condition inference model may be used to adjust and optimize new lighting effects to be applied to the image when generating the relighted image later. According to an embodiment, the image rendering may mean a process of visually expressing the generated image to the user. The main goal of the image rendering may be to generate a visual representation that accurately simulates the interaction between the light and the surface. The interaction between the light and the surface may be defined by the following rendering equation, which may be calculated by considering factors such as properties of a material, properties of lighting, and a position of an observer.

$${L}_{o} ( v ) = {\int }_{Ω} f ( v , 1 ) {L}_{i} ( 1 ) 〈 n \cdot 1 〉 d 1 \qquad ( Equation 1 )$$

The rendering equation may mean a cumulative result of incident light Li(1) coming from all possible directions on a hemisphere Ω centered on a surface normal n. Here, L₀(v) represents irradiance, i.e., the intensity of light, perceived by an observer in a direction v, which may be related to a degree of reflection and absorption of light on a surface of an object. f(v,1) may be a bidirectional reflectivity distribution function (BRDF) that describes the reflective characteristics of the surface. The BRDF defines an interaction between the observation direction v and the incident light direction 1, and may determine the direction in which light is incident on and reflected from the surface based on the defined interaction.

In an embodiment, the BRDF, expressed as f(v, 1), is intended to describe how light is reflected from an opaque surface, and since the surface intrinsically exhibits both diffuse reflection and specular reflection, the BRDF is composed of two components such as diffuse reflection f_{d} and specular reflection fₛ, which may be expressed by the following equation.

$$f ( v , 1 ) = {f}_{d} ( v , 1 ) + {f}_{s} ( v , 1 ) \qquad ( Equation 2 )$$

In an embodiment, the diffuse component serves to evenly disperse light, thereby providing a consistent lighting effect regardless of an observation angle. This allows an object to maintain similar brightness regardless of the direction from which the object is viewed, providing a more natural impression. On the other hand, the specular component generates a reflection effect that changes depending on the observation angle and the direction of light. This creates a sparkling highlight on the surface of the object, which may be an essential element in achieving realism that may be viewed in photos or videos. The specular reflection appears more distinctly as the surface is smoother, and may provide important details for realistic image rendering.

According to an embodiment, the diffuse model related to the diffuse reflection may include a Lambert reflection model. The Lambert reflection model assumes that the surface reflects light equally in all directions, which may be expressed by the following Equation 3.

$${f}_{d} ( v , 1 ) = \frac{σ}{π} [ const . ] \qquad ( Equation 3 )$$

Here, σ is the albedo, which may represent the intrinsic color and brightness of the surface. The reason for dividing the albedo by π may be to normalize the reflectivity.

In an embodiment, an Oren-Nayar model may be utilized in addition to the Lambert model as the diffuse model. The Oren-Nayar model may express the scattering of light more realistically by using the roughness of the surface as an additional parameter.

According to an embodiment, the specular model related to the specular reflection may include a Cook-Torrance model based on the microsurface theory. The Cook-Torrance model assumes the surface as a plurality of small, mirror-like reflective microsurfaces. The Cook-Torrance model may precisely render the specular reflectivity of the surface by introducing a roughness parameter a, which may be expressed by the following Equation 4.

$$f \text{?} ( v , 1 ) = \frac{D ( h , α ) G ( v , 1 , α ) F ( v , h , {f}_{0} )}{4 〈 n \cdot 1 〉 〈 n \cdot v 〉} \qquad ( Equation 4 )$$

$$\text{?} \text{indicates text missing or illegible when filed}$$

D(h,α) is a microsurface distribution function, G(v,l,α) is a geometric attenuation factor, and F(v,h,f₀) may be a Fresnel term that describes the change in reflectivity according to the observation angle. These factors may calculate the directionality of the microsurface, the shadow and masking effects, and the change in reflectivity according to the observation angle, respectively. For example, by using these elements, it is possible to precisely calculate how the microsurfaces of each surface are arranged, how the shadow and masking occur when light reaches the surface, and how the reflectivity changes depending on the position of the observer.

In an embodiment, in the Cook-Torrance model, a lower a value makes the surface smoother, resulting in sharper and more distinct specular highlight, and a higher a value makes the surface rougher, resulting in more widespread reflection. Therefore, by adjusting various a values, the Cook-Torrance model may effectively describe various types of specular reflectivity.

According to an embodiment of the present invention, based on the basic rendering equation (i.e., Equation 1), an integrated rendering equation may be derived by including the diffuse and specular components of the BRDF, which may be expressed by the following Equation 5.

$${L}_{o} ( v ) = {\int }_{Ω} ( {f}_{d} ( v , 1 ) + f \text{?} ( v , 1 ) ) E ( 1 ) 〈 n \cdot 1 〉 d 1 \qquad ( Equation 5 )$$

$$\text{?} \text{indicates text missing or illegible when filed}$$

Here, E(1) means the incident environmental lighting in the given direction 1, and f(v,1) may mean the reflection characteristics of light defined through the BRDF. That is, by mathematically modeling the complex interaction between the light and the surface, a more realistic image may be generated.

According to an embodiment of the present invention, a rendering function R may be defined to more clearly describe the concept of (Equation 5) described above, which may be expressed by the following Equation 6.

$$I = R ( n , σ , α , {f}_{0} , E ) \qquad ( Equation 6 )$$

Here, E may mean the intensity of light representing the intensity of a light source in the surrounding environment. n may be a normal vector of the surface, which may define the direction the surface is facing. σ, α, and f₀ may mean the intrinsic color and brightness of the surface, the roughness of the surface, and the basic Fresnel reflectivity of the surface, respectively. By using the rendering function that considers these factors, the image formation process may be simplified more effectively, and a more realistic image may be generated under various lighting conditions and surface characteristics.

In an embodiment, the operation of generating the albedo map based on the diffuse shading may include an operation of processing the source original image and the diffuse shading as inputs to the diffuse model to acquire the diffuse shading, and an operation of generating the albedo map based on the diffuse shading and the diffuse render.

In an embodiment, the diffuse shading model may include a network function pre-trained to output the diffuse render based on the diffuse shading corresponding to the source original image.

In a specific embodiment, the diffuse render may be generated based on the diffuse shading and the albedo map, but the accurate estimation of the albedo map may be difficult due to ambiguity in surface color and material properties, so the present invention may preferentially infer the diffuse render and acquire the albedo map based on the inferred diffuse render.

Describing in more detail, the server 100 may generate the diffuse shading based on the normal map corresponding to the source original image and the lighting condition information corresponding to the source original image. That is, the diffuse shading may be generated based on the normal map and the lighting condition information corresponding to the source original image. In the process of generating the diffuse shading, the normal map is used to calculate the incident angle of light and the directionality of the surface, and the lighting condition information may represent the distribution and intensity change of light for the source image. By combining the two pieces of information, the server 100 may generate the diffuse shading that visually expresses the diffuse effect occurring on the surface under various lighting conditions.

Specifically, the server 100 may acquire the normal map corresponding to the source original image by using the normal map generation model (NormalNet). In addition, the server 100 may acquire the lighting condition information from the source original image by using the lighting condition inference model (e.g., Illum Net). Here, the lighting condition information may include the information corresponding to the lighting condition inferred from the source original image. Thereafter, the server 100 may generate the diffuse shading in which light is incident on the surface and spreads evenly in various directions based on the extracted normal map and the lighting condition information.

In addition, in an embodiment, the server 100 may generate the diffuse render by using the generated diffuse shading and the source original image. According to an embodiment, the server 100 may process the diffuse shading and the source original image as inputs to the pre-trained network function to output the diffuse render. In an embodiment, the pre-trained network function may be a diffuseNet. The operating principle of the diffuseNet is to analyze the characteristics of the diffuse shading and the source original image, and generate the final diffuse render based on the interaction between the light and the surface, and the diffuse render (L_{src, Odiff} (v)) for the process may be expressed by the following Equation 7.

$${L}_{src} \text{?} ( v ) \frac{σ}{π} {\int }_{Ω} {E}_{src} ( 1 ) 〈 n \cdot 1 〉 d 1 \qquad ( Equation 7 )$$

$$\text{?} \text{indicates text missing or illegible when filed}$$

Here, σ/π represents a diffuse BRDF, Esrc(1) represents the lighting environment corresponding to the source image, and (n·1) may mean an incident intensity of light according to an angle that the lighting makes with the normal of the surface. Ω may be a hemisphere representing all possible lighting directions on the surface.

The above (Equation 7) may show how the diffuse render actually models the diffuse effect in which the light from the source image is incident on the surface and spreads in various directions. Based on the above Equation, the diffuseNet may calculate the complex interaction between the light of the source image and the surface within the algorithm, and may generate a diffuse render that is close to reality based on the calculated interaction.

In other words, the diffuse render may be characterized as an image in which the diffuse effect which is spreading light evenly in all directions from the surface is visually expressed as the final image generated by combining the diffuse shading and the albedo map.

According to an embodiment, the diffuse model may generate the albedo map based on the diffuse shading and the diffuse render.

In general, the accurate estimation of the albedo map may be complicated by the ambiguity of the surface color and the material properties and the shadow effect. To solve this problem, the server 100 of the present invention utilizes a method of preferentially deriving the diffuse render and then inferring the albedo map based on the derived diffuse render. That is, the diffuse render may be preferentially derived using the diffuseNet that is the deep learning model, and then the albedo map may be derived based on the derived diffuse render and the generated diffuse shading. Through this process, the true surface color that is not affected by the lighting and shadows may be more accurately predicted, which has the advantage of greatly improving albedo prediction in various real-world scenarios.

In addition, according to an embodiment, the operation of acquiring the information on the roughness and the reflectivity corresponding to the source original image based on the source original image, the normal map, and the albedo map includes the operation of processing the source original image, the normal map, and the albedo map as inputs to the specular model to acquire the information on the roughness and the reflectivity, and the specular model may include the pre-trained network function that infers specular elements of the surface based on the microsurface theory to acquire specular information including the information on the roughness and the reflectivity.

According to an embodiment, the specular model may include the pre-trained network function that may be used to accurately infer the specular characteristics of the surface based on the microsurface theory and acquire the specular information. The pre-trained network function included in the specular model may be a Specular Net. The Specular Net is an advanced deep learning algorithm designed to model and infer specular characteristics of a complex surface.

The Specular Net uses the source original image, the normal map, and the albedo map as inputs. When data is input to the Specular Net, the information on various specular characteristics including the surface roughness and reflectivity may be inferred. The Specular Net may infer the specular characteristics including the surface roughness and reflectivity from the input data through complex nonlinear transformation and pattern recognition techniques. The surface roughness is an important factor that determines the degree of dispersion of highlight generated when light is reflected on the surface, and the reflectivity indicates how well the surface reflects light, which may be closely related to the intrinsic characteristics of the material.

In an embodiment, the Specular Net may output the final image or property data reflecting the specular characteristics based on the inferred surface roughness and reflectivity information. Such output data (e.g., specular information) may be utilized in applications such as the image rendering, the material recognition, or the visual effect generation.

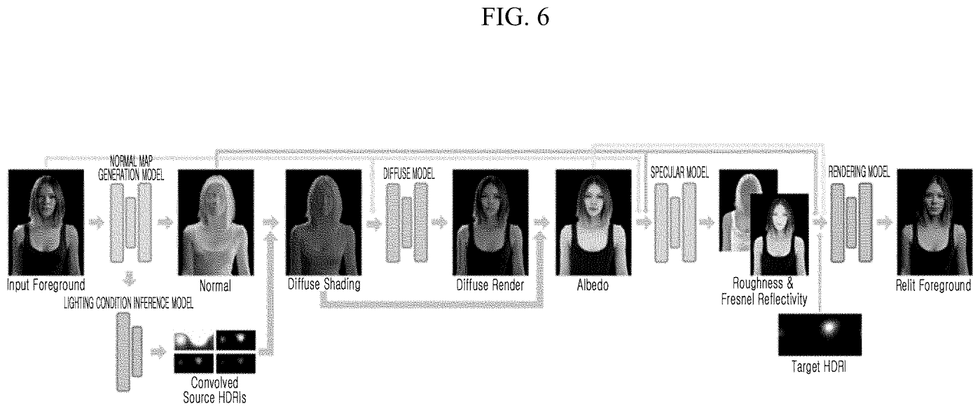

Referring to FIG. 6, first, the server 100 may generate the normal map by processing the foreground image extracted from the source original image as input to the normal map generation model. In addition, the server 100 may infer the lighting condition information corresponding to the extracted foreground image by using the lighting condition inference model.

Thereafter, the server 100 may generate the diffuse shading based on the normal map and the lighting condition information. In the process of generating the diffuse shading, the normal map is used to calculate the incident angle of light and the directionality of the surface, and the lighting condition information may represent the distribution and intensity change of light for the source image. By combining the distribution and intensity change of light for the source image, the server 100 may generate the diffuse shading that visually expresses the diffuse effect occurring on the surface under various lighting conditions.

In addition, the server 100 may generate the diffuse render by using the diffuse shading and the source original image. In an embodiment, the server 100 may be characterized by preferentially inferring the diffuse render based on the diffuse shading by using the neural network model, and inferring the albedo based on the inferred diffuse render. Specifically, the server 100 may process the diffuse shading and the source original image as inputs of the diffuse reflection net to generate the diffuse render. The diffuse render may be characterized as the image in which the diffuse effect which is spreading light evenly in all directions from the surface is visually expressed as the final image generated by combining the diffuse shading and the albedo map. The server 100 of the present invention utilizes a method of preferentially deriving the diffuse render and then inferring the albedo map based on the derived diffuse render. That is, the diffuse render may be preferentially derived using the diffuseNet that is the deep learning model, and then the albedo map may be derived based on the derived diffuse render and the generated diffuse shading. Through this process, the true surface color that is not affected by the lighting and shadows may be more accurately predicted, which has the advantage of greatly improving albedo prediction in various real-world scenarios.

In addition, the server 100 may acquire the specular information on the specular characteristics based on the original source image, the normal map, and the albedo map by using the specular model. The server 100 may process the original source image, the normal map, and the albedo map as inputs to the specular model (e.g., Specular Net) to output the final image or property data in which the specular characteristics are reflected based on the information on the roughness and the reflectivity.

Through the above-described process, the server 100 may acquire the image characteristic information corresponding to the original source image, that is, the information on the normal map, the albedo map, the roughness, and the reflectivity. The server 100 may generate the relighted image based on such image characteristic information and the target lighting condition.

According to an embodiment of the present invention, the method of generating a relighted image based on an object image may include an operation S300 of generating a relighted image based on the source original image, the image characteristic information, and the target lighting information.

In an embodiment, the target lighting information may be a target high dynamic range imaging (HDRI), which relates to the direction, color, intensity, etc., of light used to light a specific scene or object. The target HDRI includes lighting information in a high dynamic range measured in a real environment, which may be very useful for simulating and reproducing realistic lighting conditions. For example, by using HDRIs, which record various real lighting environments, such as sunrise, sunset, cloudy days, and indoor lighting, in high resolution, as the target lighting information, the rendering model may precisely reproduce how the object or scene will look under such lighting.

According to an embodiment, the operation of generating the relighted image may include an operation of generating the diffuse render and the specular render based on the normal map, the albedo map, the information on the roughness, the information on the reflectivity, and the target lighting information, an operation of generating an initial relighted image based on the diffuse render and the specular render, and an operation of processing the initial relighted image as an input to the rendering model to generate the relighted image.

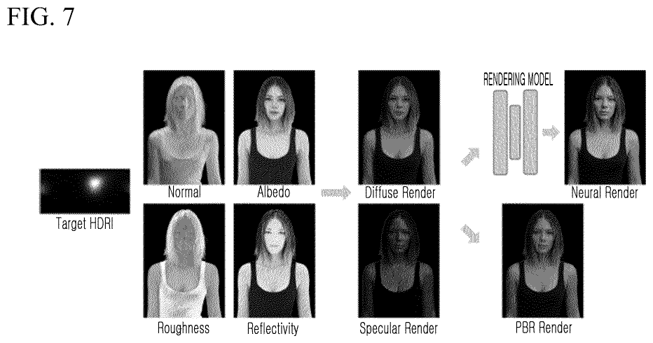

More specifically, referring to FIG. 7, the server 100 may generate the diffuse render and the specular render based on the normal map, the albedo map, the information on the roughness, and the information on the reflectivity.

Here, the diffuse render may be a simulation of a phenomenon in which light is scattered and reflected in various directions on the surface of the object, which may provide a more realistic visual effect by reflecting the texture and roughness of the object. The diffuse reflection is important in determining the basic color or texture of the surface, and the albedo map and the information on the roughness may be utilized to adjust the reflectivity.

In addition, the specular render may be a simulation of a phenomenon in which light is incident on a surface of an object at a specific angle and reflected at the same angle. This is important in expressing the shine or glossiness of an object, and may be derived using the information on the reflectivity and roughness of the object. The specular reflection is mainly prominent on smooth and glossy surfaces, and the visual effect may vary greatly depending on the direction of the light and the observation position of the object.

The server 100 may generate the initial relighted image by combining the diffuse render and the specular render. In this operation, the target lighting information (e.g., target HDRI) is used to determine the direction, intensity, color, etc., of light, and the generated renders may contribute to predicting a visual response of an object under such lighting conditions.

In an embodiment, the server 100 may generate the initial relighted image based on physics-based rendering (PBR) principles (e.g., method following the Cook-Torrance model). In an embodiment, the initial relighted image may be a PBR render. The PBR render may be an image with realistic lighting effects by modeling the interaction between the light and the object based on actual physical laws.

In a specific embodiment, the server 100 may derive the diffuse render and the specular render under the target lighting based on (Equation 3) and (Equation 4), and combine the diffuse render and the specular render to generate the PBR rendering, i.e., the initial relighted image.

The initial relighted image provides an approximation of how the object will look in a new lighting environment, and the image may be input to the rendering model to serve as a basis for generating the final relighted image. The server 100 may process the initial relighted image as input to the rendering model to generate the final relighted image.

In an embodiment, the rendering model may further refine the initial relighted image and adjust the refined initial relighted image according to new lighting conditions while maintaining the consistency with the original image.

According to a specific embodiment, the rendering model may be a neural network model that analyzes the characteristics of the source original image and generates the relighted image under the new lighting condition based on the characteristics. The rendering model may be pre-trained to output an image in the environment where the lighting has changed by comprehensively analyzing and processing the output of the specular model, the normal map, the albedo map, and the target lighting condition information as inputs.

In an embodiment, the rendering model may be pre-trained based on an integrated loss related to a weighted sum of reconstruction loss, perceptual loss, adversarial loss, and specular loss, thereby generating the realistic reconstructed image with changed lighting conditions while corresponding to the original image.

Here, the reconstruction loss may be a loss related to a pixel-level difference between an original image and a predicted result image corresponding to the original image, the perceptual loss may be a loss related to a characteristic difference between the original image and the result image, the adversarial loss may be a loss related to a difference between the original image determined by a discriminator model and the result image, and the specular loss may be a loss obtained by weighting the reconstruction loss using the specular information.

In other words, the rendering model may relight the original image under new lighting conditions by using complex input data and various loss functions. The rendering model may generate the relighted image based on the initial relighted image. In this process, the model may minimize the direct pixel value difference between the original image and the relighted image through the reconstruction loss, and reduce the visual characteristic difference between the two images through the perceptual loss to derive a more natural result. In addition, the adversarial loss may be used to make the generated images natural so that the generated images are difficult to distinguish from the real images, and the specular loss allows for more accurate simulation of the light reflection characteristics of reflective and glossy surfaces. In this way, the pre-trained rendering model through the composite learning method may effectively imitate various real lighting conditions.

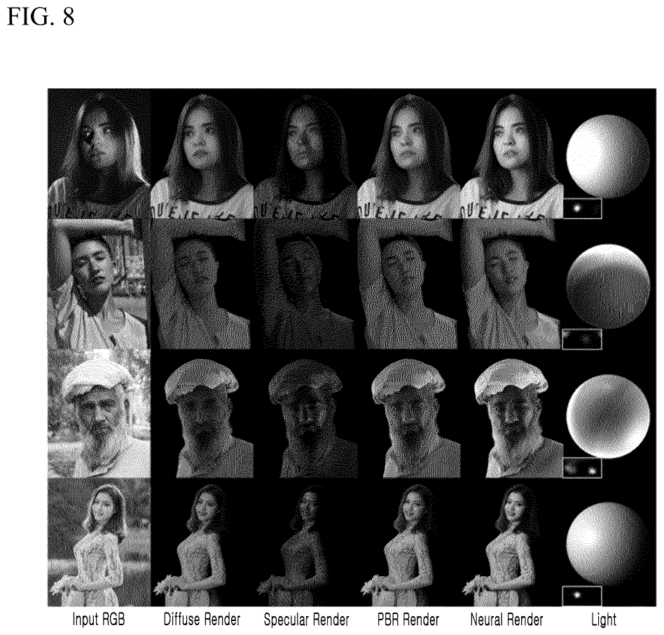

In summary, the server 100 may generate the diffuse render and the specular render based on the normal map, the albedo map, the information on the roughness and the reflectivity using the physics-based rendering (PBR) approach using the Cook-Torrance model. In addition, the server 100 may generate the initial relighted image, i.e., the PBR render, under the target lighting conditions based on the corresponding renders. In addition, the server 100 may generate the relighted image that is closer to reality by improving the image in terms of brightness, specular details, etc., using the rendering model, which may be confirmed through FIG. 8. In other words, the finally generated relighted image (neural render) is the result of the neural network, and may be based on the PBR render and expressed by capturing finer details that are difficult to be captured only with the Cook-Torrance model.

According to an embodiment of the present invention, the method of generating a relighted image based on an object image may further include constructing a training data set based on a plurality of light stage data, generating the plurality of reconstructed images corresponding to each of the plurality of source original images included in the training data set by using the image reconstruction model, and reinforcing the training data set based on the plurality of reconstructed images.

The image reconstruction model may be trained to generate the reconstructed image corresponding to the input image by reflecting the perceptual loss and the adversarial loss in the reconstruction loss regarding the difference between each source original image and each reconstructed image corresponding to each source original image.

More specifically, the server may construct the training data set by using the light stage data to collect portrait images captured under various lighting conditions. The light stage data is data generated through a light stage facility, and records a three-dimensional shape of an object or a person and the optical properties of its surface in high resolution. The light stage is a special capturing studio that is composed of a number of lighting devices (LED light and spotlight, etc.) that may provide lighting in various directions and a high-resolution camera, and captures the appearance of light reflected from the surface of the subject from multiple angles by disposing the subject in the center and applying lighting at various angles and intensities. However, this light stage data requires special capturing equipment and settings, and therefore, may be hardly acquired in the general environment.

To overcome this, the server 100 may generate a plurality of reconstructed images corresponding to each of the acquired optical stage data, and reinforce the training data set through the generated reconstructed images.

Specifically, the server 100 may process each optical stage data as input to the image reconstruction model to generate the plurality of reconstructed images corresponding to each optical stage data.

In an embodiment, the image reconstruction model of the present invention may be the neural network model that is trained to generate the reconstructed images by using the dynamic masking that dynamically adjusts one or more patches with various sizes to various areas of the input image.

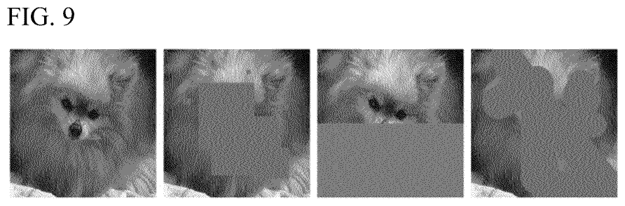

The image reconstruction process of the image reconstruction model of the present invention may reflect complex image characteristics and various lighting conditions by applying a more dynamic and flexible masking technique beyond a simple patch-based approach. For example, the image reconstruction model may utilize the dynamic masking to reconstruct various areas of the image into various sizes and shapes, rather than simply applying a patch with a certain size to the input image and reconstructing the corresponding patch part to generate the reconstructed image. As illustrated in FIG. 9, by using overlapping patches with various sizes, outpainting masks, free-form masks, etc., the image reconstruction model may reconstruct specific parts of an image in more detail. For a specific example, in areas with detailed features such as eyes or mouth of a face, small-sized patches may be applied to achieve high-resolution reconstruction. On the other hand, in areas with backgrounds or less important features, large patches may be used to process a wider area at once. In this way, by using the dynamic mask that determines the sizes and shapes of patches for each area differently, the model may maintain the overall harmony while preserving the important features of the image, and generate the reconstructed images in more diverse forms.

This dynamic masking method has the advantage of allowing the model to handle important elements, such as changes in lighting or details of specific objects in the image, more precisely, and as a result, achieve more realistic and natural relighting effects.

In other words, the image reconstruction model may generate the reconstructed image by considering not only the overall composition of the image, but also the details of specific areas. For example, it allows the neural network to train how specific parts of the face or specific elements of the background change depending on lighting. In addition, through the dynamic masking, it is possible to maximize the effect of the relighting by selectively emphasizing some areas of the image or by differently processing specific areas.

In particular, the image reconstruction model of the present invention is trained by applying the reconstruction loss that minimizes the difference between each source original image and the corresponding reconstructed image, and the perceptual loss and the adversarial loss to preserve the texture and details of the image and derive more natural results, so that the generated image is not only reproduced very closely to the original, but also includes the subtle visual effects according to the changes in lighting. Through this process, the neural network may understand more complex image characteristics and various lighting conditions, and effectively generate the reconstructed image with realistic lighting effects.

In other words, as the image reconstruction model secures the plurality of reconstructed images and reinforces the training data set, the information to learn during the neural network learning increases. As the diversity and size of the training data set increase, the neural network trains more sophisticated pattern recognition and image processing functions, thereby implementing the realistic lighting effects. This has the advantage of allowing the neural network to preserve the fine details of the image while generating the natural relighting effects under various lighting environments.

In summary, the server 100 may perform the training on the unlabeled data through the self-supervised pre-training framework and provide the realistic relighted images tailored to the user's needs based on the training. That is, the server 100 may automate the relighting of the portrait image reflecting the lighting changes in various real-world scenarios by using the architecture that integrates the physics-based approach and the self-supervised pre-training framework, and provide the enhanced realism to the user.

Throughout this specification, a computational model, a neural network, a network function, and a neural network may be used as the same meaning. The neural network may generally be composed of a set of interconnected computational units, which may be referred to as “nodes”. These “nodes” may also be referred to as “neurons.” The neural network is configured to include at least one node. The nodes (or neurons) that constitute a neural network may be interconnected by one or more “links.”

A deep neural network (DNN) may refer to a neural network including a plurality of hidden layers in addition to an input layer and an output layer. It is possible to identify latent structures of data by using the deep neural network. That is, it is possible to identify the latent structures (e.g., what objects are in the photo, what the content and emotion of the text are, what the content and emotion of the audio are, etc.) of a photo, text, video, sound, or music. The deep neural network may include a convolutional neural network (CNN), a recurrent neural network (RNN), an auto encoder, generative adversariall networks (GAN), a restricted Boltzmann machine (RBM), a deep belief network (DBN), a Q network, a U network, a Siamese network, and the like. The description of the deep neural network described above is only an example, and the present invention is not limited thereto.

The neural network may be trained in at least one of supervised learning, unsupervised learning, and semi supervised learning. The training of the neural network is to minimize errors in output. The training of the neural network learning is a process of repeatedly inputting training data to the neural network, calculating an output of the neural network for the training data and target errors, and updating weights of each node of the neural network by back-propagating errors of the neural network from an output layer of the neural network to an input layer in order to reduce the errors. In the case of the supervised learning, training data in which correct answers are labeled for each training data is used (i.e., labeled training data), and in the case of the unsupervised learning, correct answers may not be labeled for each training data. That is, for example, in the case of the supervised learning for data classification, the training data may be data in which each category is labeled for training data. The labeled training data is input to the neural network, and an error may be calculated by comparing the output (category) of the neural network with the label of the training data. As another example, in the case of the unsupervised learning for the data classification, the error may be calculated by comparing the input training data with the output of the neural network. The calculated error is backpropagated in a backward direction (i.e., a direction from an output layer to an input layer) in the neural network, and connection weights of each node in each layer of the neural network may be updated according to the backpropagation. The amount of change in the connection weights of each node to be updated may be determined according to a learning rate. The calculation of the neural network for the input data and the backpropagation of the error may constitute a learning cycle (epoch). The learning rate may be applied differently depending on the number of times of repetitions of the learning cycle of the neural network. For example, in the early stage of the training of the neural network, a high learning rate may be used to allow the neural network to quickly acquire a certain level of performance, thereby increasing efficiency, and in the later stage of the training, a low learning rate may be used to increase accuracy.

Operations of the method or algorithm described with reference to the embodiment of the present invention may be directly implemented in hardware, in software modules executed by hardware, or in a combination thereof. The software module may reside in a RAM, a ROM, an EPROM, an EEPROM, a flash memory, a hard disk, a removable disk, a CD-ROM, or in any form of computer-readable recording media known in the art to which the invention pertains.

The components of the present invention may be embodied as a program (or application) and stored in media for execution in combination with a computer which is hardware. The components of the present invention may be executed in software programming or software elements, and similarly, embodiments may be realized in a programming or scripting language such as C, C++, Java, and assembler, including various algorithms implemented in a combination of data structures, processes, routines, or other programming constructions. Functional aspects may be implemented in algorithms executed on one or more processors.

Those skilled in the art will appreciate that various exemplary logical blocks, modules, processors, means, circuits, and algorithm steps described in connection with the embodiments disclosed herein may be implemented by electronic hardware, various forms of programs or design codes (herein, for convenience, referred to as “software”), or a combination thereof. To clearly describe this interchangeability of hardware and software, various exemplary components, blocks, modules, circuits, and steps have been generally described above in terms of their functionality. Whether these functions are implemented as hardware or software depends on the specific application and the design constraints imposed on the overall system. Those skilled in the art will appreciate that each particular application may implement the described functionality in a variety of ways, but such implementation decisions should not be interpreted as deviating from the scope of the present invention.

Various embodiments presented herein may be implemented as methods, devices, or manufactured articles using standard programming and/or engineering techniques. The term “manufactured article” includes a computer program, carrier, or media accessible from any computer-readable device. For example, the computer-readable medium includes, but is not limited to, magnetic storage devices (e.g., hard disk, floppy disk, magnetic strip, etc.), optical disks (e.g., compact disc (CD), digital versatile disc (DVD), etc.), smart cards, and flash memory devices (e.g., EEPROM, card, stick, key drive, etc.). In addition, various storage media presented herein include one or more devices and/or other machine-readable media for storing information. The term “machine-readable medium” includes, but is not limited to, wireless channels and various other media capable of storing, retaining, and/or transmitting instructions(s) and/or data.

It is to be understood that particular order or hierarchy of steps in presented processes is an example of exemplary approaches. It is to be understood that the specific order or hierarchy of steps in processes may be rearranged within the scope of the present invention, based on design priorities. The appended method claims provide elements of various steps in a sample order but are not meant to be limited to the particular order or hierarchy presented.

According to various embodiments of the present invention, by generating the relighted image corresponding to the source original image, it is possible to provide the convenience for real-time image processing and lighting adjustment. As a result, it is possible to allow users to preview the visual effects of the image under various lighting conditions, and provide practicality, especially in the fields of the video production, game development, virtual reality, etc. In other words, since various lighting conditions may be quickly simulated, it is possible to not only contribute to the productivity improvement, but also expand the range of the creative visual expression.

In addition, according to the present invention, it is possible to improve the consistency of the original image while increasing the quality of the relighted image by using the architecture that integrates the physics-based approach and the self-supervised pre-training framework. This is a configuration that generates the images close to the reality, and has the advantage of improving the user experience and providing more realistic visual results.

Effects of the present invention are not limited to the effects described above, and other effects that are not mentioned may be obviously understood by those skilled in the art from the following description.

The description of the presented embodiments is provided to enable any person skilled in the art to make or use the present invention. Various modifications to these embodiments will be apparent to those skilled in the art, and the general principles defined herein may be applied to other embodiments without departing from the scope of the invention. Therefore, the present invention is not limited to the embodiments presented herein, but is to be construed in the broadest scope consistent with the principles and novel features presented herein.

What is claimed is:

1. A method of generating a relighted image based on an object image performed by one or more processors of a computing device, the method comprising:
acquiring a source original image;
acquiring image characteristic information based on the source original image; and
generating the relighted image based on the source original image, the image characteristic information, and target lighting information.

2. The method of claim 1, wherein the relighted image is an image reflecting characteristics of an object under target lighting conditions, and an image whose lighting effect is changed compared to the source original image.

3. The method of claim 2, wherein the relighted image is an image reflecting a realistic human skin tone, texture, and shadow effect under the target lighting conditions.

4. The method of claim 1, wherein the acquiring of the image characteristic information includes:
extracting a foreground image from the source original image through a foreground extraction model; and
performing reverse rendering on the extracted foreground image to acquire the image characteristic information,
wherein the image characteristic information is information on physical and optical properties of a surface corresponding to the foreground image, and includes at least one of a normal map, an albedo map, information on roughness, information on reflectivity, and lighting condition information.

5. The method of claim 4, wherein the performing of the reverse rendering to acquire the image characteristic information includes:
deriving the normal map corresponding to the source original image using a normal map generation model;
deriving the lighting condition information corresponding to the source original image using a lighting condition inference model;
generating diffuse shading based on the normal map and the lighting condition information;
generating the albedo map based on the diffuse shading; and
acquiring the information on the roughness and the reflectivity corresponding to the source original image based on the source original image, the normal map, and the albedo map.

6. The method of claim 5, wherein the generating of the albedo map based on the diffuse shading includes:
processing the source original image and the diffuse shading as inputs to a diffuse model to acquire a diffuse render; and
generating the albedo map based on the diffuse shading and the diffuse render,
wherein the diffuse model includes a pre-trained network function to output the diffuse render based on the diffuse shading corresponding to the source original image, and
the diffuse render is a final image generated by combining the diffuse shading and the albedo map, and an image in which a diffuse effect which is spreading light evenly in all directions from the surface is visually expressed.

7. The method of claim 5, wherein the acquiring of the information on the roughness and the reflectivity corresponding to the source original image based on the source original image, the normal map, and the albedo map includes processing the source original image, the normal map, and the albedo map as inputs to a specular model to acquire the information on the roughness and the reflectivity, and
the specular model includes a pre-trained network function to acquire specular information including the information on the roughness and the reflectivity by inferring a specular element of the surface based on microsurface theory.

8. The method of claim 4, wherein the generating of the relighted image includes:
generating a diffuse render and a specular render based on the normal map, the albedo map, the information on the roughness, the information on the reflectivity, and the target lighting information;
generating an initial relighted image based on the diffuse render and the specular render; and
processing the initial relighted image as an input of a rendering model to generate the relighted image,
wherein the rendering model is a pre-trained neural network model based on an integrated loss related to a weighted sum of a reconstruction loss, a perceptual loss, an adversarial loss, and a specular loss, and
the reconstruction loss is a loss related to a pixel-level difference between an original image and a predicted result image corresponding to the original image, the perceptual loss is a loss related to a characteristic difference between the original image and the result image, the adversarial loss is a loss related to a difference between the original image determined by a discriminator model and the result image, and the specular loss is a loss obtained by weighting the reconstruction loss using specular information.

9. The method of claim 8, further comprising:
constructing a training data set based on a plurality of optical stage data;
generating a plurality of reconstructed images corresponding to each of a plurality of source original images included in the training data set by using an image reconstruction model; and
reinforcing the training data set based on the plurality of reconstructed images,
wherein the image reconstruction model is trained to generate the reconstructed image corresponding to an input image by reflecting the perceptual loss and the adversarial loss in the reconstruction loss regarding the difference between each source original image and each reconstructed image corresponding to each source original image.

10. The method of claim 9, wherein the image reconstruction model is trained to generate the plurality of reconstructed images by using dynamic masking that dynamically adjusts one or more patches with various sizes to various areas of the input image.

11. An apparatus, comprising:
a memory configured to store one or more instructions; and
a processor configured to execute the one or more instructions stored in the memory,
wherein the processor performs the method of claim 1 by executing the one or more instructions.

12. A computer-readable recording medium having recorded thereon a program for executing a method of generating a relighted image based on an object image in conjunction with a computing device, wherein the method comprises:
acquiring a source original image;
acquiring image characteristic information based on the source original image; and
generating the relighted image based on the source original image, the image characteristic information, and target lighting information.
